(19) United States
(12) Patent Application Publication
(10) Pub. No.: US 2007/0210987 A1
(43) Pub. Date: Sep. 13, 2007

(54) Image Display Device and Image Display Method

(76) Inventors: Yasunobu Hashimoto, Kawasaki (JP); Yoshito Seo, Kawasaki (JP); Katsuya Irie, Kawasaki (JP); Kenji Awamoto, Kawasaki (JP)

Correspondence Address: STAAS & HALSEY LLP, SUITE 700, 1201 NEW YORK AVENUE, N.W., WASHINGTON, DC, 20005, US

(21) Appl. No.: 10/577,669

(22) PCT Filed: Jul. 30, 2004
(86) PCT No.: PCT/JP04/10911

§ 371 Date: Jan. 19, 2007

(51) Int. Cl. G09G 3/20

(52) U.S. Cl. 345/60

(57) ABSTRACT

The present invention relates to an image display device that includes a display screen where subpixels emitting colored light of each color are arranged cyclically so as to repeat every predetermined display pixel pitch at least in a predetermined rotation arrangement direction and displays images on the display screen. The image display device displays images based on image data having a resolution higher than a resolution determined by the display pixel pitch after minimizing color differences from colors expressed by the image data. A weighting operation is performed which corresponds to a state where each data point is arranged not to overlap with the center of each subpixel to calculate data corresponding to each subpixel.

### TECHNICAL FIELD

The present invention relates to an image display device that includes a display screen where subpixels emitting colored light of each color are arranged cyclically so as to repeat every predetermined display pixel pitch at least in a predetermined cyclic arrangement direction and displays images on the display screen.

### BACKGROUND ART

Plasma display panels (PDPs) have recently received attention as one of display media for displaying high-resolution images. The PDP includes a panel having a thickness of approximately 1 centimeter and the thickness of the PDP can be substantially reduced. Further, the PDP can display widescreen and high-definition images. In addition, the PDP can display bright images because many display pixels arranged two-dimensionally are driven concurrently.

The PDP typically has a structure in which subpixels emitting colored light of respective colors of R (red), G (green) and B (blue) are arranged cyclically so as to repeat every display pixel pitch in a predetermined direction (herein referred to as a “cyclic arrangement direction”), many of the cyclic arrangement is provided in the direction orthogonal to the cyclic arrangement direction, many display pixels made up of the respective sets of such subpixels are arranged two-dimensionally overall, light emission intensity of many of the subpixels constituting the display pixels is controlled, and thereby color images are displayed on the PDP.

Conventionally, there is proposed a technique of using a structure in which one display pixel is made up of plural subpixels arranged in the cyclic arrangement direction to display images having a resolution higher than a resolution determined by a display pixel pitch with respect to the cyclic arrangement direction (see non-patent document 1).

FIG. 1 is an explanatory diagram of a method for displaying on a PDP input data having a pixel pitch (herein referred to as a “data pixel pitch”) smaller than a display pixel pitch, i.e., input data having a resolution higher than a resolution determined by the display pixel pitch.

Here, suppose that one display pixel is made up of three subpixels that are arranged in the cyclic arrangement direction to emit colored light of R (red), G (green) and B (blue) respectively and input data have a data pixel pitch of two-thirds of a pitch of a display pixel (a display pixel pitch) made up of the three subpixels. The input data are input data including color data of three colors of R (red), G (green) and B (blue) at each of data points arranged at data pixel pitches.

Since the data pixel pitch has an interval of two-thirds of the display pixel pitch, the respective data points are arranged to overlap with every other subpixel. Then, with respect to a subpixel with which an input data point overlaps, e.g., a subpixel Sᵢ shown in FIG. 1, of three color data of R, G and B constituting data of a data point Iⱼ, color data equal to colored light of the subpixel Sᵢ (here color data of G) are used without change as data of the subpixel. Further, with respect to a subpixel between two adjacent input data points, e.g., a subpixel Sᵢ₊₁, of three color data of R, G and B corresponding to the respective data points Iⱼ and Iⱼ₊₁ on the both sides of the subpixel Sᵢ₊₁, color data equal to colored light of the subpixel Sᵢ₊₁, (here color data of B) are weighted and both the weighted color data are added at the rate of 0.5 to 0.5. The color data thus obtained are used as data of the subpixel Sᵢ₊₁. Such operations make it possible to apply data having a data pixel pitch smaller than a display pixel pitch to each subpixel, then to display images having a resolution higher than a resolution determined by the display pixel pitch with respect to the cyclic arrangement direction.
Non-patent document 1: Michiel A Klompenhouwer, Gerad de Haan and Rob A. Beuker “Subpixel Image Scaling for Color Matrix Displays”, SID 2002 DIGEST, pp. 176-179

### DISCLOSURE OF THE INVENTION

### Problems to be Solved by the Invention

FIG. 2 is an explanatory diagram of a problem of the method explained with reference to FIG. 1.

Here, suppose that input data are data having a data pixel pitch of two-thirds of a display pixel pitch, as is the case with FIG. 1, and white (all of R, G and B have the maximum value, e.g., data value of 255) and black (all of R, G, and B have the minimum value, e.g., data value of zero) are repeated alternately.

In such a situation, even if subpixels corresponding to black data points are subpixels emitting any colored light, the subpixels are not lighted and black (K) is expressed because the data value is zero. In contrast, subpixels corresponding to white data points are lighted depending on colored light emitted by the respective subpixels. For example, in the case of the subpixels emitting colored light of G, data of G (data value of 255) among data of white (all of R, G and B have a data value of 255, for example) at data points corresponding to the subpixels are applied, so that the subpixels are lighted in green. Similarly, when subpixels corresponding to the white data points are subpixels emitting colored light of R or B, data of R or B among data of white are applied, so that the subpixels are lighted in red or blue. Thus, it turned out that colors are expressed in displayed images and further images having a pattern in which colors of R, G and B are repeated cyclically are displayed, despite a repetitive pattern of white and black originally.

Here, descriptions are provided of the repetitive pattern of achromatic colors (white and black) as a simple example. Similarly, it turned out that, with respect to a pattern of chromatic colors, colors on a display screen differ from colors on data.

An object of the present invention is to provide an image display device for displaying images based on image data having a resolution higher than a resolution determined by a display pixel pitch after minimizing color differences from colors expressed by the image data.

### Means for Solving the Problems

An image display device according to the present invention for achieving the object described above is an image display device that includes a display screen where subpixels emitting colored light of each color are arranged cyclically so as to repeat every predetermined display pixel pitch at least in a predetermined cyclic arrangement direction and displays images on the display screen. The image display device includes a data conversion portion for converting image data having pixel data each of which is associated with each data point when the data points are arranged at a data pixel pitch smaller than the display pixel pitch in the cyclic arrangement direction to converted image data having converted pixel data each of which is associated with each subpixel data corresponding to each of the subpixels, and a display control portion for controlling the colored light of each of the subpixels arranged in the display screen based on each of the subpixel data that was converted by the data conversion portion, and thereby to display images on the display screen. The data conversion portion performs, for each of the subpixels, an operation for generating subpixel data corresponding to the subpixel by adding weight depending on a distance between the center of the subpixel and each of the data points to plural color data corresponding to the colored light of the subpixel and combining the plural color data together, the plural color data, in a state, constituting plural pixel data associated with the data points that are present within a predetermined area extending from the center of the subpixel to both sides in the cyclic arrangement direction, the state being a state where the data points are arranged in the display screen in a manner to overlap with the subpixels at positions where the respective data points are off the respective centers of the subpixels in the cyclic arrangement direction.

In the image display device according to the present invention, a weighting operation is performed which corresponds to a state where each data point is arranged not to overlap with the center of each subpixel to calculate data corresponding to each subpixel. Thereby, images having a resolution higher than a resolution determined by a display pixel pitch are displayed on a display screen in colors that are similar to colors on image data compared to conventional cases.

In the image display device according to the present invention, the predetermined area may be an area extending from the center of the subpixel to both sides in the cyclic arrangement direction by an amount corresponding to one display pixel pitch respectively.

The excess extension of the area may cause a high spatial-frequency component to be reduced, resulting in the reduction of the resolution. Further, the excess extension of the area requires time for operations. For these reasons, it is preferable to use an area extending to both sides by an amount corresponding to one display pixel pitch respectively as described above.

In the image display device according to the present invention, with respect to the cyclic arrangement direction, the data pixel pitch may be represented by an equation:
P_{d}={(n−i)/n}·Pₒ
where Pₒ denotes the display pixel pitch, n denotes the number of subpixels within one display pixel pitch, P_{d} denotes the data pixel pitch and i is an integer (1≦i<n).

The display pixel pitch Pₒ and the data pixel pitch P_{d} have the relationship indicated by the ratio of integer as shown above. Thereby, it is possible to perform an operation corresponding to a state where the data points overlap with the subpixels in such a manner that all the data points are off the respective centers of the subpixels.

Among the relationship expressed by the above equation, when the number of subpixels n is three and the integer i is one, the data pixel pitch P_{d} may be expressed as an equation:
P_{d}=(⅔)·Pₒ

The display pixel is usually made up of three subpixels emitting colored light of R, G and B respectively. In such a case, the present invention is suitable for displaying image data having a data pixel pitch P_{d} (P_{d}=(⅔)Pₒ) that is a length corresponding to two subpixels.

The image display device according to the present invention includes, instead of the data conversion portion, a data conversion portion for converting image data having pixel data each of which is associated with each data point when the data points are arranged at a data pixel pitch smaller than the display pixel pitch in the cyclic arrangement direction to each subpixel data corresponding to each of the subpixels. The data conversion portion performs a first operation for each imaginary pixel corresponding to each of the subpixels and a second operation for each of the subpixels, the first opeation being an operation for generating imaginary pixel data corresponding to one imaginary pixel corresponding to the subpixel by adding weight depending on the distance between the center of the subpixel and each of the data points to the plural pixel data associated with the data points that are present within the predetermined area extending from the center of the subpixel to both sides in the cyclic arrangement direction and combining the plural pixel data together in the state where the data points are arranged in the display screen in a manner to overlap with the subpixels at the positions where the respective data points are off the respective centers of the subpixels in the cyclic arrangement direction, the second operation being an operation for generating subpixel data corresponding to the subpixel by combining the plural color data corresponding to the colored light of the subpixel, and the plural color data constituting the plural imaginary pixel data that correspond to the imaginary pixel corresponding to the subpixel and imaginary pixels arranged around the imaginary pixel.

In such a case, in addition to the operation corresponding to the overlap with displacement described above, an average operation of surrounding plural data points is performed, so that images having a resolution higher than a resolution determined by a display pixel pitch can be displayed in colors that are more similar to colors on data.

An image display method according to the present invention for achieving the object described above is an image display method for an image display device that includes a display screen where subpixels emitting colored light of each color are arranged cyclically so as to repeat every predetermined display pixel pitch at least in a predetermined cyclic arrangement direction and displays images on the display screen. The image display method includes performing, for each of the subpixels, an operation for generating subpixel data corresponding to the subpixel by adding weight depending on a distance between the center of the subpixel and each of the data points to plural color data corresponding to the colored light of the subpixel and combining the plural color data together, the plural color data, in a state, constituting plural pixel data associated with the data points that are present within a predetermined area extending from the center of the subpixel to both sides in the cyclic arrangement direction, the state being a state where data points are aligned at a data pixel pitch smaller than the display pixel pitch in the cyclic arrangement direction and are arranged in the display screen in a manner to overlap with the subpixels at positions where the respective data points are off the respective centers of the subpixels in the cyclic arrangement direction, controlling the colored light of each of the subpixels arranged in the display screen based on each of the subpixel data generated by the operation, and displaying images on the display screen.

### EFFECTS OF THE INVENTION

As described above, the present invention makes it possible to, with respect to the cyclic arrangement direction, display images that have small color differences from colors on data and have a resolution higher than a resolution defined by a display pixel pitch compared to conventional cases.

### BRIEF DESCRIPTION OF THE DRAWINGS

FIG. 1 is an explanatory diagram of a method for displaying on a PDP input data having a “data pixel pitch” smaller than a display pixel pitch, i.e., input data having a resolution higher than a resolution determined by the display pixel pitch.

FIG. 2 is an explanatory diagram of a problem of the method explained with reference to FIG. 1.

FIG. 3 is a block diagram showing one embodiment of an image display device according to the present invention.

FIG. 4 is a diagram showing arrangement of subpixels and arrangement of data points on a PDP.

FIG. 5 is a graph showing measurement results of a shift amount from a white color for a displaced amount.

FIG. 6 is an explanatory diagram of a data conversion algorithm in a second embodiment.

FIG. 7 is a graph showing measurement results of a shift amount from a white color for a displaced amount when the data conversion algorithm in the second embodiment is adopted.

### BEST MODE FOR CARRYING OUT THE INVENTION

Hereinafter, embodiments of the present invention will be described with reference to the drawings.

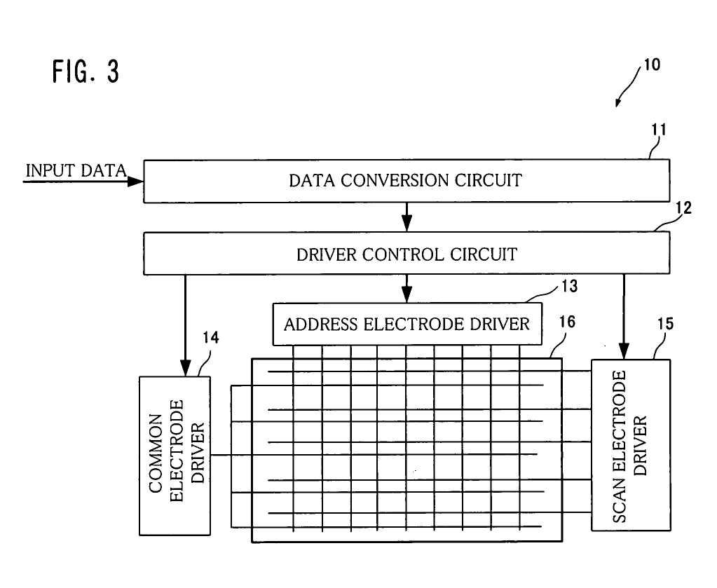

FIG. 3 is a block diagram showing one embodiment of an image display device according to the present invention.

In the image display device shown in FIG. 3, blocks are shown including a data conversion circuit 11, a driver control circuit 12, an address electrode driver 13, a common electrode driver 14, a scan electrode driver 15 and a plasma display panel (PDP) 16. The data conversion circuit 11 corresponds to one example of a data conversion portion according to the present invention. The combination of the driver control circuit 12, the address electrode driver 13, the common electrode driver 14 and the scan electrode driver 15 correspond to one example of a display control portion according to the present invention. The PDP 16 corresponds to one example of a display screen according to the present invention.

The data conversion circuit 11 serves to convert input data to display data. The display data produced by the data conversion circuit 11 are inputted to the driver control circuit 12. The driver control circuit 12 operates to control the three drivers (the address electrode driver 13, the common electrode driver 14 and the scan electrode driver 15) to display images on the PDP 16. Subpixels of R, G and B are cyclically arranged in the PDP 16 in the horizontal direction (one example of the cyclic arrangement direction according to the present invention) and many lines made up of the arrangement of the subpixels are arranged in the PDP 16 in the vertical direction. The PDP 16 displays color images on the display screen including many display pixels, each of which is made up of three subpixels of R, G and B, arranged two-dimensionally.

The structure is conventionally known of using the driver control circuit 12 to control the three drivers (the address electrode driver 13, the common electrode driver 14 and the scan electrode driver 15), then to display images on the PDP 16 and the structure is not the subject matter of the present invention. Accordingly, further descriptions about it are omitted herein. Descriptions are provided below of details of a data conversion algorithm in the data conversion circuit 11.

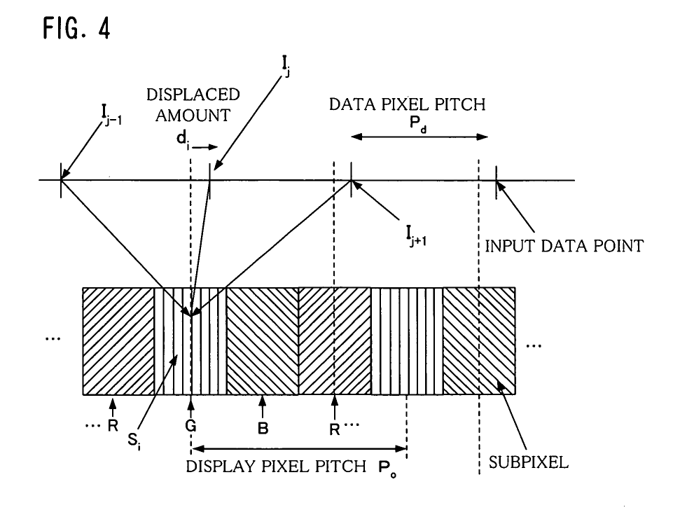

FIG. 4 is a diagram showing arrangement of subpixels and arrangement of data points on a PDP.

FIG. 4 shows arrangement of subpixels of a part of one line where the subpixels emitting colored light of R, G and B respectively are arranged cyclically in the horizontal direction. The repetition of the subpixels of R, G and B as shown in FIG. 4 is arranged in the horizontal direction on the PDP 16 shown in FIG. 3 and many lines of the subpixel arrangement each of which has the same structure as one line arranged in the horizontal direction are arranged in the vertical direction on the PDP 16. One display pixel is made up of three subpixels of R, G and B and a data pixel pitch P_{d} has a length of two-thirds of a display pixel pitch Pₒ.

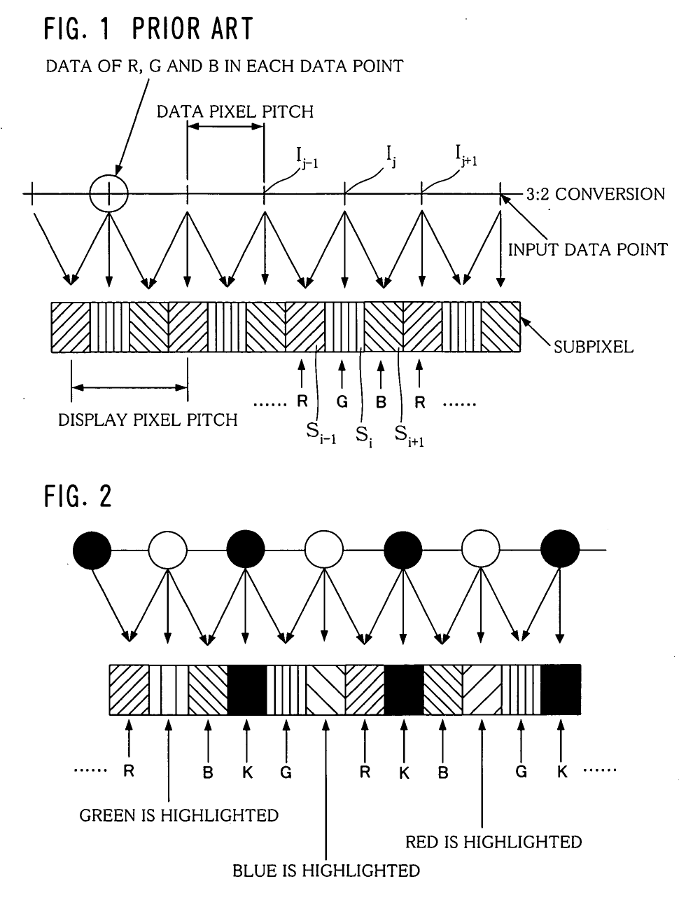

FIG. 4 is a drawing corresponding to FIG. 1 by which a conventional example is described. FIG. 4 differs from FIG. 1 in that input data points are off the respective centers of the subpixels in the horizontal direction.

The equation below shows the relationship between input data and data to be set to a subpixel. The following are definitions of symbols.

Sᵢ: data to be set to a target subpixel

Iⱼ: data of a data point closest to a target subpixel

dᵢ: position of an input data point closest to a target subpixel when the center of the subpixel is made a reference

Pₒ: display pixel pitch

P_{d}: data pixel pitch

uᵢ: lower limit of an index of a data point used for data calculation of a target subpixel

vᵢ: upper limit of an index of a data point used for data calculation of a target subpixel

The following definition is a weighting function for calculating data to be set to a subpixel when input data are added together.

$$\begin{matrix}[ Equation 1 ] & \\ \begin{matrix}ρ ( x ) = 1 - \frac{\vert x \vert}{{P}_{o}} & ( - {P}_{o} \leq x \leq {P}_{o} )\end{matrix} & ( 1 )\end{matrix}$$

where x is an index of a data point when the center of a target subpixel is made a reference. An input data point to be used for the calculation is an input data point arranged at a position where a distance between a target subpixel and the input data point is shorter than a display pixel pitch.

This weighting function is used to set data of a subpixel in accordance with the following equation.

$$\begin{matrix}[ Equation 2 ] & \\ {S}_{i} = \frac{{\sum }_{k = {u}_{i}}^{{v}_{i}} ρ ( {kP}_{d} + {d}_{i} ) {I}_{j + k}}{{\sum }_{k = {u}_{i}}^{{v}_{i}} ρ ( {kP}_{d} + {d}_{i} )} & ( 2 )\end{matrix}$$

Here, color data of three colors of R, G and B are present in each of the input data points. When data to be set to a subpixel is determined, data having the same color as colored light emitted by the target pixel are used.

Here, equation (2) is applied to FIG. 4, so that the following relationship is obtained.

$$\begin{matrix}[ Equation 3 ] & \\ {S}_{i} = \frac{\begin{matrix}( 1 - ( {P}_{d} - {d}_{i} ) / {P}_{o} ) \cdot {I}_{j - 1} + ( 1 - {d}_{i} / {P}_{o} ) \cdot \\ {I}_{j} + ( 1 - ( {P}_{d} + {d}_{i} ) / {P}_{o} ) \cdot {I}_{j + 1}\end{matrix}}{\begin{matrix}( 1 - ( {P}_{d} - {d}_{i} ) / {P}_{o} ) + ( 1 - {d}_{i} / {P}_{o} ) + \\ ( 1 - ( {P}_{d} + {d}_{i} ) / {P}_{o} )\end{matrix}} & ( 3 )\end{matrix}$$

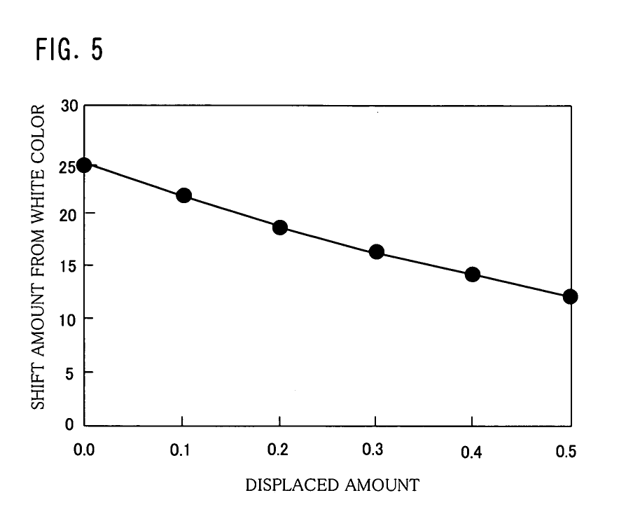

FIG. 5 is a graph showing measurement results of a shift amount from a white color for a displaced amount.

Suppose that the case of FIG. 4 (P_{d}=(⅔)Pₒ, equation (3)) is shown and data of white and data of black are alternately assigned to each data point as shown in FIG. 2.

The “displaced amount” specified in the horizontal axis is a ratio (dᵢ/((⅓)·Pₒ)=3dᵢ/Pₒ) of a displaced amount dᵢ shown in FIG. 4 to a dimension ((⅓·Pₒ) of one subpixel in the horizontal direction. The “shift amount from a white color” specified in the vertical axis is 1000 times a numerical value in Δuv unit. The case where the displaced amount in the horizontal axis is zero corresponds to the conventional example described with reference to FIGS. 1 and 2.

As understood from FIG. 5, a weighting operation is performed with a data point being off the center of a subpixel, which reduces a color shift.

Next, descriptions will be provided of a second embodiment of the image display device according to the present invention.

With the second embodiment, a structure of the image display device is the same as that shown in the block diagram of FIG. 3 according to the first embodiment. The image display device according to the second embodiment differs from that of the first embodiment only in data conversion algorithm in the data conversion circuit 11 shown in FIG. 3. Hereinafter, descriptions are provided of a data conversion algorithm according to the second embodiment.

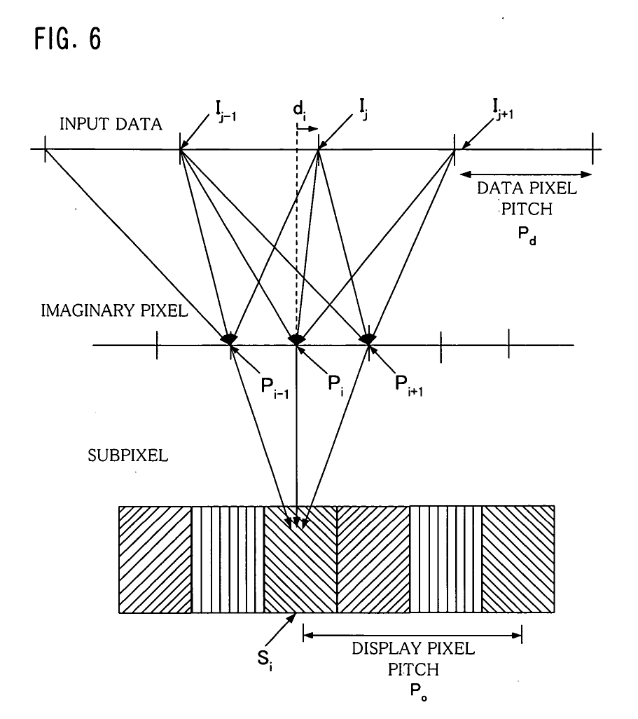

FIG. 6 is an explanatory diagram of a data conversion algorithm in the second embodiment.

Imaginary pixels are assumed which correspond to the subpixels on a one-to-one basis.

A pitch between data points of input data (a data pixel pitch) is two-thirds of a display pixel pitch, i.e., is twice a subpixel pitch and an imaginary pixel pitch.

A data point of the input data is arranged at a position that is off the center of the imaginary pixel by a displaced amount dᵢ.

The same operations as equations (2) and (3) shown above are used for calculating data to be applied to the imaginary pixel. In the first embodiment, however, the operations of equations (2) and (3) are performed only on color data corresponding to colored light emitted by a target subpixel. In the second embodiment, instead, the operations based on equations (2) and (3) are performed on all color data of three colors of R, G and B. In this way, data . . . Pᵢ₋₁, Pᵢ, Pᵢ₊₁, . . . corresponding to each of the imaginary pixels are determined. With respect to an operation of data of a target subpixel, the following equation (4) is used to determine the average of an imaginary pixel corresponding to the subpixel and imaginary pixels therearound (here, the total three imaginary pixels including two imaginary pixels arranged in the front and the rear of the imaginary pixel corresponding to the subpixel respectively.
Sᵢ=(Pᵢ₋₁+Pᵢ+Pᵢ₊₁)/3 (4)
The operation based on equation (4) is performed only on color data corresponding to a color of the target pixel.

The idea of the imaginary pixels is adopted to describe an operation algorithm. However, for the practical operation, it is unnecessary to separate the operation based on equation (3) and the operation based on equation (4) from each other and it is possible to perform an operation of the combination of equation (3) and equation (4).

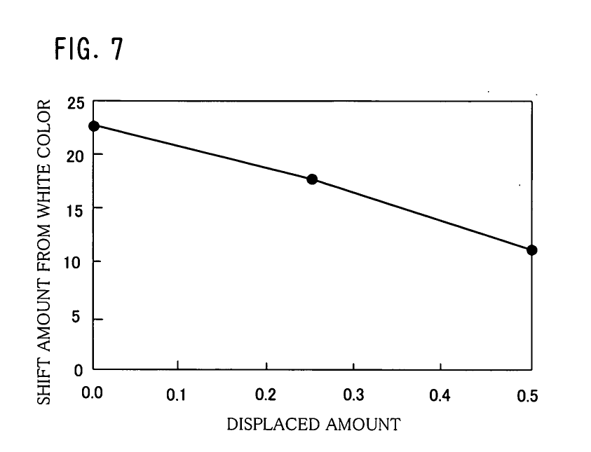

FIG. 7 is a graph showing measurement results of a shift amount from a white color for a displaced amount when the data conversion algorithm in the second embodiment, which is described with reference to FIG. 6, is adopted.

As is the case with FIG. 5, suppose that data of white and data of black are alternately assigned to each data point as shown in FIG. 2.

The “displaced amount” specified in the horizontal axis is a ratio (dᵢ/((⅓)·Pₒ)=3dᵢ/Pₒ) of a displaced amount dᵢ shown in FIG. 6 to a dimension ((⅓)·Pₒ ) of one subpixel in the horizontal direction. The “shift amount from a white color” specified in the vertical axis is 1000 times a numerical value in Δuv unit.

As understood from FIG. 7, the weighting operation is performed with data points being off the respective centers of subpixels and further the average operation of plural imaginary pixels is performed, leading to the further reduction of a color shift.

In the present specification, while a PDP is described as an example, the present invention is not limited to PDPs and is applicable to liquid crystal displays, CRT displays and others.

1. An image display device that includes a display screen where subpixels emitting colored light of each color are arranged cyclically so as to repeat every predetermined display pixel pitch at least in a predetermined cyclic arrangement direction and displays images on the display screen, the device comprising:
a data conversion portion for converting image data having pixel data each of which is associated with each data point when the data points are arranged at a data pixel pitch smaller than the display pixel pitch in the cyclic arrangement direction to converted image data having converted pixel data each of which is associated with each subpixel data corresponding to each of the subpixels; and
a display control portion for controlling the colored light of each of the subpixels arranged in the display screen based on each of the subpixel data that was converted by the data conversion portion, and thereby to display images on the display screen,
wherein, the data conversion portion performs, for each of the subpixels, an operation for generating subpixel data corresponding to the subpixel by adding weight depending on a distance between the center of the subpixel and each of the data points to plural color data corresponding to the colored light of the subpixel and combining the plural color data together, the plural color data, in a state, constituting plural pixel data associated with the data points that are present within a predetermined area extending from the center of the subpixel to both sides in the cyclic arrangement direction, the state being a state where the data points are arranged in the display screen in a manner to overlap with the subpixels at positions where the respective data points are off the respective centers of the subpixels in the cyclic arrangement direction.

2. The image display device according to claim 1, wherein the predetermined area is an area extending from the center of the subpixel to both sides in the cyclic arrangement direction by an amount corresponding to one display pixel pitch respectively.

3. The image display device according to claim 1, wherein, with respect to the cyclic arrangement direction, the data pixel pitch is represented by an equation:
P_{d}={(n−i)/n}·Pₒ
where Pₒ denotes the display pixel pitch, n denotes the number of subpixels within one display pixel pitch, P_{d} denotes the data pixel pitch and i is an integer (1≦i<n).

4. The image display device according to claim 3, wherein when the number of subpixels n is three and the integer i is one, the data pixel pitch P_{d} is expressed as an equation:
P_{d}=(⅔)·Pₒ

5. The image display device according to claim 1, further comprising, instead of the data conversion portion, a data conversion portion for converting image data having pixel data each of which is associated with each data point when the data points are arranged at a data pixel pitch smaller than the display pixel pitch in the cyclic arrangement direction to each subpixel data corresponding to each of the subpixels,
wherein, the data conversion portion performs a first operation for each imaginary pixel corresponding to each of the subpixels and a second operation for each of the subpixels, the first opeation being an operation for generating imaginary pixel data corresponding to one imaginary pixel corresponding to the subpixel by adding weight depending on the distance between the center of the subpixel and each of the data points to the plural pixel data associated with the data points that are present within the predetermined area extending from the center of the subpixel to both sides in the cyclic arrangement direction and combining the plural pixel data together in the state where the data points are arranged in the display screen in a manner to overlap with the subpixels at the positions where the respective data points are off the respective centers of the subpixels in the cyclic arrangement direction, the second operation being an operation for generating subpixel data corresponding to the subpixel by combining the plural color data corresponding to the colored light of the subpixel, and the plural color data constituting the plural imaginary pixel data that correspond to the imaginary pixel corresponding to the subpixel and imaginary pixels arranged around the imaginary pixel.

6. An image display method for an image display device that includes a display screen where subpixels emitting colored light of each color are arranged cyclically so as to repeat every predetermined display pixel pitch at least in a predetermined cyclic arrangement direction and displays images on the display screen, the method comprising:
performing, for each of the subpixels, an operation for generating subpixel data corresponding to the subpixel by adding weight depending on a distance between the center of the subpixel and each of the data points to plural color data corresponding to the colored light of the subpixel and combining the plural color data together, the plural color data, in a state, constituting plural pixel data associated with the data points that are present within a predetermined area extending from the center of the subpixel to both sides in the cyclic arrangement direction, the state being a state where data points are aligned at a data pixel pitch smaller than the display pixel pitch in the cyclic arrangement direction and are arranged in the display screen in a manner to overlap with the subpixels at positions where the respective data points are off the respective centers of the subpixels in the cyclic arrangement direction;
controlling the colored light of each of the subpixels arranged in the display screen based on each of the subpixel data generated by the operation; and
displaying images on the display screen.
